(19) United States
(12) Patent Application Publication
(10) Pub. No.: US 2012/0284077 A1
(43) Pub. Date: Nov. 8, 2012

(54) AUTOMATED WORK ORDER GENERATION FOR MAINTENANCE

(75) Inventors: GUOXIAN XIAO, Troy, MI (US); STEPHAN R. BILLER, Birmingham, MI (US); QING CHANG, Woodbury, NY (US); JORGE F. ARINEZ, Rochester Hills, MI (US); ROBERT P. CLINANSMITH, Leonard, MI (US); KEVIN VAN KLEECK, Lapeer, MI (US)

(73) Assignee: GM GLOBAL TECHNOLOGY OPERATIONS LLC, Detroit, MI (US)

(21) Appl. No.: 13/102,167

(22) Filed: May 6, 2011

(51) Int. Cl. G06Q 10/00

(52) U.S. Cl. 705/7.15

(57) ABSTRACT

A method for generating an electronic work order for plant maintenance includes detecting a fault of a machine in the plant, and communicating fault information to a system. The system has a server and a database for recording downtime of the machine. The method further includes generating the work order via the server in response to the fault, including recording, within in the work order, a plurality of values from the fault information. The work order is transmitted from the server to a computing device, and a confirmation signal is recorded by the computing device indicating completion of the repair. The method includes transmitting a completed work order from the computing device to the server and recording the completed work order in the database. A system is also disclosed for generating an electronic work order for maintenance in a plant. The system includes the database and server noted above.

### TECHNICAL FIELD

The present disclosure relates to a method and a system for generating a maintenance-related work order in a plant or other facility.

### BACKGROUND

Modern manufacturing plants use a variety of automated machines to perform a host of independent and interdependent manufacturing process steps. The ever increasing reliance on such machines has greatly improved overall production efficiency and throughput. However, machines are inherently prone to wear and tear, and thus certain fault and/or preventative maintenance conditions are expected. Some of these conditions are transient, and can be easily corrected and/or reset by a line operator. For instance, a part may become temporarily stuck on a conveyor line, or a power switch may be inadvertently tripped. The line can be quickly reset after the fault condition is cleared without significantly impacting production. Other fault conditions may be far more critical, such as a mechanical and/or electrical failure on a main production line within the plant.

Maintenance supervisors and skilled trades personnel therefore must be ready to react quickly to the various possible faults. Devoting scarce maintenance resources to relatively minor problems may occur when maintenance information is not communicated through the plant in an effective manner. Conventional maintenance methods tend to rely heavily on call alerts and/or verbal communication between line operators, maintenance supervisors, and skilled trades personnel. Recording and reporting of the host of possible fault conditions is frequently reliant on the data entry diligence and accuracy of the various maintenance personnel.

### SUMMARY

A method is disclosed herein for generating an electronic work order for reporting and recording a maintenance action in a plant or other facility. The method includes detecting a fault condition of a machine located in the plant, and communicating a set of fault information describing the fault condition to a server and a database configured for recording a downtime of the machine. The method further includes generating the electronic work order by the server in response to the fault condition, including recording, within the electronic work order, a plurality of values from the set of fault information prior to the repair. The electronic work order is transmitted from the server to a computing device. A confirmation signal is recorded by the computing device indicating completion of the repair. The method includes transmitting a completed work order from the computing device to the server in response to the confirmation signal and recording the completed work order in the database.

A system is also disclosed for generating an electronic work order for maintenance in a plant. The system includes the database and server noted above. The server is in networked communication with the database, and with each of a programmable logic controller (PLC) and a computing device. The server is configured for generating the electronic work order in response to a detection of a fault condition by the PLC, including recording, within the electronic work order, a plurality of values from a set of fault information provided from the PLC. The server is also configured for transmitting the electronic work order to the computing device, receiving a confirmation signal from the computing device confirming a completion of a repair of the fault, and recording a completed work order in the database in response to the confirmation signal.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of an automated system for generating and completing electronic work orders in a plant or other facility.

FIG. 2 is a flow chart describing a method for using the system shown in FIG. 1.

### DETAILED DESCRIPTION

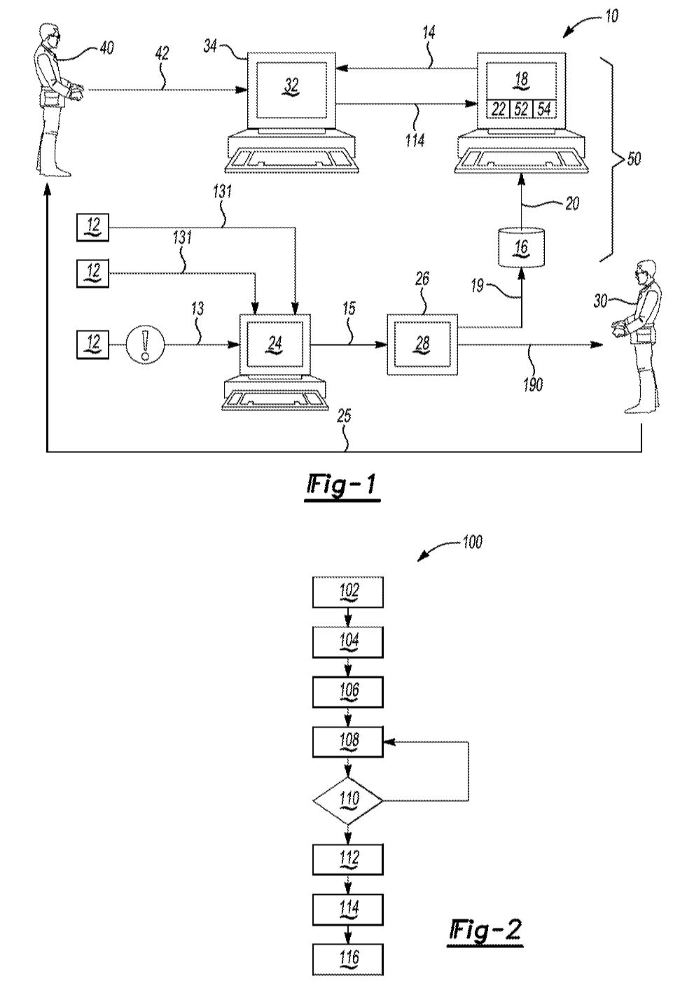

Referring to the drawings, wherein like reference numbers correspond to like or similar components throughout the several figures, a plant 10 is shown schematically in FIG. 1. The plant 10 may be embodied as a manufacturing facility or other plant in which multiple machines 12 are used to execute various automated processes. The machines 12 may be, by way of example, hydraulic or pneumatic presses, conveyors, welding machines, paint guns, or any other machine which an operator may use to complete or facilitate completion of a given work task.

The plant 10 includes the present automated work order generation (WOGEN) system 50. The system 50 is configured to automatically generate and transmit an electronic work order 14 for all types of machinery faults, thus rendering the documentation and execution of emergency maintenance (EM) efforts faster, easier, and more accurate relative to conventional methods. As set forth below, the system 50 integrates work order generation with fault reporting processes within the plant 10 so that a majority of items detailed in the work order 14 are automatically pre-filled/completed by the system 50 using information transmitted from a fault reporting device 26 and recorded in a database 16. Additionally, the system 50 may be configured with calibrated thresholds for triggering generation of the work order 14, and for classifying the work order 14 once it has been generated.

The WOGEN system 50 includes the database 16 and a host machine or server 18. The database 16 may be, by way of example, a database management system (DBMS), an application database in a proprietary format, a relational database management system (RDBMS), or any other suitable database having a structure and functionality suitable for performing its designated tasks, as explained below with reference to FIG. 2. The database 16 may employ, by way of example, the Structured Query Language (SQL) in addition to a suitable language for creating, storing, editing, and retrieving information.

The database 16 and the server 18 communicate with each other over a network connection 20, e.g., an Ethernet connection, a controller area network (CAN) bus, a wireless connection, or another suitable communications link. Hardware components of the WOGEN system 50 may include one or more digital computers each having a microprocessor or central processing unit (CPU), read only memory (ROM), random access memory (RAM), electrically-programmable read only memory (EPROM), a high-speed clock, analog-to-digital (A/D) and digital-to-analog (D/A) circuitry, and input/output circuitry and devices (I/O), as well as appropriate signal conditioning and buffer circuitry.

Each set of algorithms or computer-executable instructions residing within the WOGEN system 50 or readily accessible and executable thereby, including any algorithms or computer instructions needed for executing the present method 100 as explained below with reference to FIG. 2, may be stored in tangible, non-transitory computer-readable memory 22 and executed by associated hardware portions of the server 18 as needed to provide the disclosed functionality.

The WOGEN system 50 is in networked communication with the various machines 12 in the plant 10 via a programmable logic controller (PLC) 24, e.g., a proportional-integral (PI) or a proportional-integral-derivative (PID) feedback control device of the type known in the art. In the embodiment shown in FIG. 1, a single PLC 24 is used for a plurality of the machines 12. However, those of ordinary skill in the art will understand that a dedicated PLC 24 may be used with each of the machines 12, or a designated PLC 24 may be used with certain types or clusters of machines 12, depending on the particular layout and control scheme of the plant 10.

The PLC 24 communicates with the database 16 through the fault reporting device 26. In one embodiment, the fault reporting device 26 may be configured as an Andon system, which as well understood in the art refers to a manufacturing system used to notify management, maintenance, and other workers of an existing quality or process problem. An Andon system may be embodied as a marquis or a signboard 28 which incorporates, for example, color coded and/or patterned signal lights indicating which of the various machines 12 is presently experiencing a fault condition. Such a fault condition is indicated by the symbol “!” in FIG. 1.

The initial alert signal (arrow 13) in response to a fault from a machine 12 can be generated manually by an operator, e.g., using a pull cord or an emergency stop (E-stop) button (not shown), or the alert signal (arrow 13) may be activated automatically by the machine 12, for instance generated by one or more sensors (not shown). The fault is received and registered by the PLC 24, which can then relay a PLC alert code (arrow 15) to the fault reporting device 26. Properly functioning machines 12 may periodically or continuously transmit a status signal (arrows 131) indicating that the machine 12 is properly functioning.

Therefore, when a given machine 12 in the plant 10 experiences a fault condition, the fault is ultimately transmitted by the PLC 24 to the fault reporting device 26. A user 30, for instance a maintenance supervisor, is initially alerted to the existing fault by the sign board 28. However, unlike conventional methods which proceed from this point by seeing the user 30 verbally request a skilled trades person 40 to repair the fault condition, followed by completion of a repair report by the skilled trades person 40 after the repair, work order generation as set forth herein proceeds automatically and proactively using the system 50 and its communications with the fault reporting device 26.

More specifically, along with alerting the user 30 via the fault reporting device 26, the fault reporting device 26 also transmits detailed fault information (arrow 19) to the WOGEN system 50 where the detailed fault information (arrow 19) is recorded in the database 16. Visual information (arrow 190) is also communicated to the user 30 via the signboard 28, e.g., identifying the location and the particular machine 12 requiring maintenance attention. The user 30 can therefore commence repair manpower tasking from skilled trades person 40 without worrying about work order generation.

That is, the database 16 may be configured as a down time reporter (DTR), and thus the database 16 may immediately begin to record and track the downtime of the machine 12 experiencing the fault condition while the fault condition remains active. The server 18 automatically opens the electronic work order 14 and records some of the detailed fault information (arrow 19) from the fault reporting device 26. For instance, the server 18 may record in the work order 14 one or more of the following example data elements: a work order number, the location of the machine 12 experiencing the fault condition, an equipment identifier indentifying, for instance, the model, serial number, and/or type of machine 12 to be repaired, a start time for the fault, a description of the type of fault, repair status, and reporting time, e.g., a time at which the repair commences. In another embodiment, all of the example fields noted above are recorded by the server 18 when the electronic work order 14 is generated.

The user 30 can task the skilled trades person 40 via a suitable task notification path (arrow 25), e.g., verbally, via a cell phone, radio, email, text message, or other suitable manual and/or electronic means. When the repair is complete, the skilled trades person 40 performing the repair enters a confirming signal (arrow 42) into a computing device 34, e.g., by pressing a confirm button or icon on a touch screen 32 in one possible embodiment. The computing device 34 records the confirming signal (arrow 42), and transmits a completed work order 114 to the server 18 for recording in the database 16. In one embodiment, the computing device 34 may be configured as a host machine running suitable asset management and maintenance software such as IBM's Maximo® software.

Still referring to FIG. 1, the server 18 may be programmed with a set of thresholds 52, 54. The server 18 may generate the electronic work order 14 only when the detailed fault information (arrow 19) exceeds one of the thresholds 52, 54. For instance, threshold 52 may be a downtime threshold. A significant portion of faults are short in duration/operator reset, and therefore require neither emergency nor corrective maintenance. Conventional methods may still trigger a dispatch of a repair technician due to indication via the signboard 28. The present system 50 instead uses the thresholds 52 and 54 to determine precisely when to generate the electronic work order 14.

Threshold 52 may be set arbitrarily in one embodiment, e.g., 3 minutes, such that any fault not resolved within that duration automatically triggers generation of the electronic work order 14 by the server 18. In another embodiment, the server 18 may calculate the threshold 52 on a rolling basis using historical/statistical data reported to the server 18 by the database 16, e.g., as a function of the mean time after a calibrated repair time cut, e.g., 3 minutes, and of the mean time to repair such a fault. Changes to the various mean repair times and repair cut time will necessarily vary the threshold 52 over time, so this embodiment may be used to more closely tailor the threshold 52 to actual repair results over time.

Threshold 54 may be set by the various types of machines 12 in the plant 10. That is, certain machines 12 may be designated as process critical, and therefore any failure in these machines may immediately trigger generation of an electronic work order 14. Threshold 54 may be used to differentiate certain lines as being main lines or sub-lines, and thus the server 18 may be configured to prioritize a given electronic work order 14 based on the criticality of its use within the plant 10.

Component replacement records for the various machines 12 may be provided by the database 16 to the server 18, and used to determine the impact of a given fault of a particular machine 12 on overall production in the plant 10. Such information can be used over time to tailor the threshold 54 to actual data. In one embodiment, the server 18 may calculate Cohen's Kappa number, as understood in the statistical arts, to determine the degree of agreement between real data in the database 16 and assumptions used for setting the threshold 54. The threshold 54 may be adjusted accordingly using such results.

Referring to FIG. 2 in conjunction with the structure shown in FIG. 1, a method 100 for generating an electronic work order 14 in the plant 10 is shown in a flow chart format. Beginning with step 102, a fault condition is detected at a particular machine 12. Step 102 may entail an operator and/or the machine 12 generating the initial alert signal (arrow 13) in response to a fault. The method 100 proceeds to step 104 once the initial alert signal (arrow 13) has been generated.

At step 104, the initial alert signal (arrow 13) is received and recorded or registered by the PLC 24. Once this occurs, the method 100 proceeds to step 106.

At step 106, the PLC 24 generates and transmits a PLC alert code (arrow 15) to the fault reporting device 26. The method 100 proceeds to step 108 once the PLC alert code (arrow 15) has been relayed.

At step 108, the fault reporting device 26 passes detailed fault information (arrow 19) to the WOGEN system 50. The database 16 records the detailed fault information (arrow 19), including at least the downtime from the machine 12 presently experiencing the fault condition.

At step 110, the server 18 compares certain elements of the detailed fault information (arrow 19) to the calibrated thresholds 52, 54, and determines whether generation of an electronic work order 14 is required. Step 110 may entail comparing the downtime of the machine 12 experiencing the fault condition to the threshold 52 to determine if the downtime has exceeded or is likely to exceed the threshold 52. Step 110 may alternatively or concurrently include comparing the machine 12 and type of fault condition to the threshold 54 as explained above.

The result of step 110 may be a decision as to whether or not to generate the electronic work order 14, as well as the priority of the electronic work order 14. For instance, if the fault condition exceeds the calibrated threshold 52, the other threshold 54 may still have to be satisfied in order for an EM electronic work order 14 to be warranted, otherwise a lower priority corrective maintenance (CR) electronic work order 14 may be more appropriate. The method 100 proceeds to step 112 after this decision has been made by the server 18 at step 110.

At step 112, the server 18 generates the electronic work order 14 at the priority decided at step 110. As noted above, the electronic work order 14 is pre-filled with the detailed fault information (arrow 19) and relayed to the computing device 34. The method 100 proceeds to step 114.

At step 114, upon completing a maintenance action, the skilled trades person 40 thereafter confirms completion of the maintenance action by entering the confirming signal (arrow 42). Step 114 may optionally include the skilled trades person 40 changing some information in the electronic work order 14 if necessary, e.g., correcting a model number or location of the machine 12 experiencing the fault, or updating the root cause of the fault condition. Such a change is included as part of the confirming signal (arrow 42). Once the confirming signal is entered, the method 100 proceeds to step 116.

At step 116 the completed work order 114 is transmitted to the sever 18 and recorded in the database 16 and/or other suitable locations to facilitate reporting of the maintenance action.

While the best modes for carrying out the invention have been described in detail, those familiar with the art to which this invention relates will recognize various alternative designs and embodiments for practicing the invention within the scope of the appended claims.

1. A method for generating an electronic work order for reporting and recording a maintenance action in a plant, comprising:
detecting a fault condition of a machine located in the plant;
communicating a set of detailed fault information describing the fault condition to each of a server and a database, wherein the server and the database are collectively configured for recording a downtime of the machine;
generating the electronic work order by the server in response to the fault condition, including recording, within the electronic work order, a plurality of values from the set of detailed fault information;
transmitting the electronic work order from the server to a computing device;
recording a confirmation signal, via the computing device, indicating a completion of the maintenance action, wherein the maintenance action includes a correction or repair of the fault condition;
transmitting a completed work order from the computing device to the server in response to the confirmation signal; and
recording the completed work order in the database to facilitate the reporting of the maintenance action.

2. The method of claim 1, wherein detecting a fault condition is performed by a programmable logic controller.

3. The method of claim 1, further comprising displaying some of the set of detailed fault information using a signboard.

4. The method of claim 1, wherein generating an electronic work order further includes assigning each of a downtime threshold and a fault type threshold, recording the thresholds in memory of the server, and using the thresholds to assign a priority to the electronic work order.

5. The method of claim 1, wherein recording a confirmation signal includes updating information in the electronic work order.

6. A method for generating an electronic work order for reporting and recording a maintenance action in a plant, comprising:
detecting and recording a fault condition of a machine in the plant using a programmable logic controller (PLC);
communicating the fault from the PLC to an Andon system;
transmitting a set of detailed fault information describing the fault condition from the Andon system to a server and a database, wherein the database is configured for recording the downtime of the machine;
generating the electronic work order using the server in response to the detailed fault information only when the downtime of the machine exceeds a calibrated downtime threshold, including recording a plurality of values from the detailed fault information in the electronic work order;
transmitting the electronic work order to a computing device;
confirming completion of the electronic work order by recording a confirmation signal via the computing device; and
recording a completed work order in the database in response to the confirmation signal.

7. The method of claim 6, further comprising identifying the location within the plant of the machine experiencing the fault condition, and generating the electronic work order at a maintenance priority which corresponds to the location of the machine.

8. The method of claim 6, further comprising periodically updating the calibrated downtime threshold via the server using statistical information from the database.

9. A system for generating an electronic work order for reporting and recording a maintenance action in a plant, the system comprising:
a database; and
a server in networked communication with the database, and with each of a programmable logic controller (PLC) and a computing device;
wherein the server is configured for:
generating, via the PLC, the electronic work order in response to detection of a fault condition of a machine in the plant, including recording, within the electronic work order, a plurality of values from a set of detailed fault information provided from the PLC;
transmitting the electronic work order to the computing device;
receiving a confirmation signal from the computing device confirming a completion of the maintenance action; and
recording a completed work order in the database in response to the confirmation signal to thereby facilitate reporting of the maintenance action.

10. The system of claim 9, wherein the server is configured for calculating each of a downtime threshold and a fault type threshold, and for using the thresholds to assign a priority to the electronic work order.

11. The system of claim 10, wherein the server is configured for periodically updating the calibrated downtime threshold using statistical information from the database.

12. The system of claim 9, wherein the server is in networked communication with the PLC through an Andon machine.
